(19) United States
(12) Patent Application Publication
(10) Pub. No.: US 2022/0027865 A1
(43) Pub. Date: Jan. 27, 2022

(54) PASSIVE RESOURCE COLLECTION AND TRANSFORMATION SYSTEM

(71) Applicant: BANK OF AMERICA CORPORATION, Charlotte, NC (US)

(72) Inventors: Justin Riley DuPont, Charlotte, NC (US); Charles Jason Burrell, Middleburg, FL (US); Tony England, Tega Cay, SC (US); Catherine Goss, Newark, DE (US); Michael Robert Hasslinger, Huntersville, NC (US); Christina Ann Lillie, Ann Arbor, MI (US); John Allen Sellers, Kennett Square, PA (US); Vincent Butler, Hockessin, DE (US); John Livaditis, Hockessin, DE (US); Karen Lea MacQueen, Lyndhurst, OH (US); Ana Maxim, Arlington, VA (US)

(73) Assignee: BANK OF AMERICA CORPORATION, Charlotte, NC (US)

(21) Appl. No.: 16/935,542

(22) Filed: Jul. 22, 2020

(51) Int. Cl. G06Q 20/06; G06Q 20/38; G06Q 20/36; G06Q 40/02; G06Q 20/22

(52) U.S. Cl. CPC G06Q 20/0655; G06Q 20/381; G06Q 20/223; G06Q 40/02; G06Q 20/3672

(57) ABSTRACT

Embodiments of the invention are directed to a system, method, or computer program product for an auxiliary hub for passive resource conversion and collection. The system generations and provides a centralized hub for passive resource conversion. The passive resources may be linked from a third party to the hub for direct extraction of the passive resource to the hub. Furthermore, the system may translate the passive resource into active resource via a modification ratio based on the type of passive resource and passive resource provider. The user may then be able to utilize this centralized auxiliary hub for completion or partial completion of resource distributions. The invention further provides a graphical user interface that integrates the centralized auxiliary hub with user mobile applications, on-line applications, and the like allowing for partial selection from the hub and other resource sources for distribution.

### BACKGROUND

An entity may provide auxiliary resources to a user for utilizing standard resources from a standard source associated with the entity to complete a resource distribution. The auxiliary resources may be associated with an auxiliary source associated with the user and maintained by the entity. However, tracking and maintaining auxiliary resources and auxiliary sources consumes computing resources and/or network resources. Accordingly, when auxiliary resources are not utilized by users, the computing resources and/or network resources consumed tracking and maintaining the auxiliary resources and auxiliary sources are wasted.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Currently, users have an expanded rewards collection from credit cards, third party rewards accounts, and the like that are collected as passive or auxiliary resources. The invention provides a centralized functioning deposit account for the user for utilization of the passive resources across any merchant or deposit function. This centralized functioning deposit account may be an auxiliary deposit account that stores converted passive resources into usable deposit resources for the user. The user may then be able to utilize this centralized auxiliary account for completion of person-to-person (P2P) transactions, transactions at a merchant, or the like. As such, the user may be able to select from checking, savings, of this auxiliary account to transfer money via P2P. In this way, the invention enables rewards as a funding/deposit account. The invention further provides a graphical user interface that allows for user splitting of resources for a single transaction between multiple accounts. As a funding source, the invention allows for the auxiliary account to go over the send limit for items like P2P payments or other digital payments. The system may also allow for universal transfer of rewards across various third party entities into the centralized auxiliary account for the user. In this way, the invention provides a real-time identification of rewards available within the centralized auxiliary account before or during a transaction. The system may also link to a user's digital wallet for easy access and visualization.

Embodiments of the present invention address these and/or other needs by providing an innovative system, method and computer program product for passive resource transformation, the invention comprising: creating a communication linkage with third party passive resource providers; receiving passive resources from the third party passive resource providers specific for a user; converting the passive resources; storing the converted passive resources in a centralized auxiliary resource account; integrating the auxiliary resource account into user channels; triggering term modification of resource distribution upon user selection of the auxiliary resource account for a resource distribution; and adjusting the auxiliary resource account.

In some embodiments, converting the passive resources comprises determining a type of passive resource and converting the passive resource into a deposit resource in a ration based on a relative value of the passive resource.

In some embodiments, receiving passive resources from the third party passive resource providers further comprises extracting the passive resources from the third party passive resource providers for the user based on user authorization.

In some embodiments, adjusting the auxiliary resource account further comprises modifying an amount of resources in the auxiliary resource account based on user use of the auxiliary resource account for transactions and a real-time integration of the passive resources received from the third party passive resource providers specific for the user.

In some embodiments, the term modification comprises a modification and increase of a resource distribution limit for P2P transactions using the auxiliary resource account. In some embodiments, the term modification comprises allowing the use of the auxiliary resource account and another deposit account to complete a single transaction.

In some embodiments, third party passive resource providers comprise entities providing products or services to the user and including a reward in the form of a passive resource to the user for interaction with the third party passive resource provider.

In some embodiments, integrating the auxiliary resource account into user channels further comprises integrating the auxiliary resource account with deposit accounts of the user within a mobile application for resource distribution.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a passive resource collection and transformation system environment, in accordance with one embodiment of the present invention;

FIG. 2 provides a high level process flow illustrating setting up the passive resource collection and auxiliary resource account hub, in accordance with one embodiment of the present invention;

FIG. 3 provides a process flow illustrating utilization of the auxiliary resource account hub, in accordance with one embodiment of the present invention; and

FIG. 4 provides a graphical user interface of the auxiliary resource account hub integration, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any individual with one or more deposit accounts and/or one or more passive resource accounts with third party merchants. The user may interact with a merchant and provide resources for completion of a transaction with a merchant using a user deposit account. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “resource distribution” refers to any transaction or other communication between a user and a customer to transfer funds for the purchasing or selling of a product or service. A transaction may refer to a purchase of goods or services, a return of goods or services, a payment transaction, a credit transaction, or other interaction involving an account. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the mobile distribution device may be a point-of-transaction device (POT) may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, an “account” refers to a credit account, a debit/deposit account, or the like. Although the phrase “bank account” includes the term “bank,” the account need not be maintained by a bank and may, instead, be maintained by other financial institutions. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a user device, and in yet other embodiments, it refers to both a customer device and a user device interacting to perform a transaction. For example, in one embodiment, the point-of-transaction device refers to the user's mobile device configured to communicate with a customer device, whereas in other embodiments, the point-of-transaction device refers to a terminal configured to communicate with a user's mobile device and customer's mobile device, and in yet other embodiments, the point-of-transaction device refers to both.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

Currently, users have an expanded rewards collection from credit cards, third party rewards accounts, and the like that are collected as passive or auxiliary resources. The invention provides a centralized functioning deposit account for the user for utilization of the passive resources across any merchant or deposit function. This centralized functioning deposit account may be an auxiliary deposit account that stores converted passive resources into usable deposit resources for the user. The user may then be able to utilize this centralized auxiliary account for completion of person-to-person (P2P) transactions, transactions at a merchant, or the like. As such, the user may be able to select from checking, savings, of this auxiliary account to transfer money via P2P. In this way, the invention enables rewards as a funding/deposit account. The invention further provides a graphical user interface that allows for user splitting of resources for a single transaction between multiple accounts. As a funding source, the invention allows for the auxiliary account to go over the send limit for items like P2P payments or other digital payments. The system may also allow for universal transfer of rewards across various third party entities into the centralized auxiliary account for the user. In this way, the invention provides a real-time identification of rewards available within the centralized auxiliary account before or during a transaction. The system may also link to a user's digital wallet for easy access and visualization.

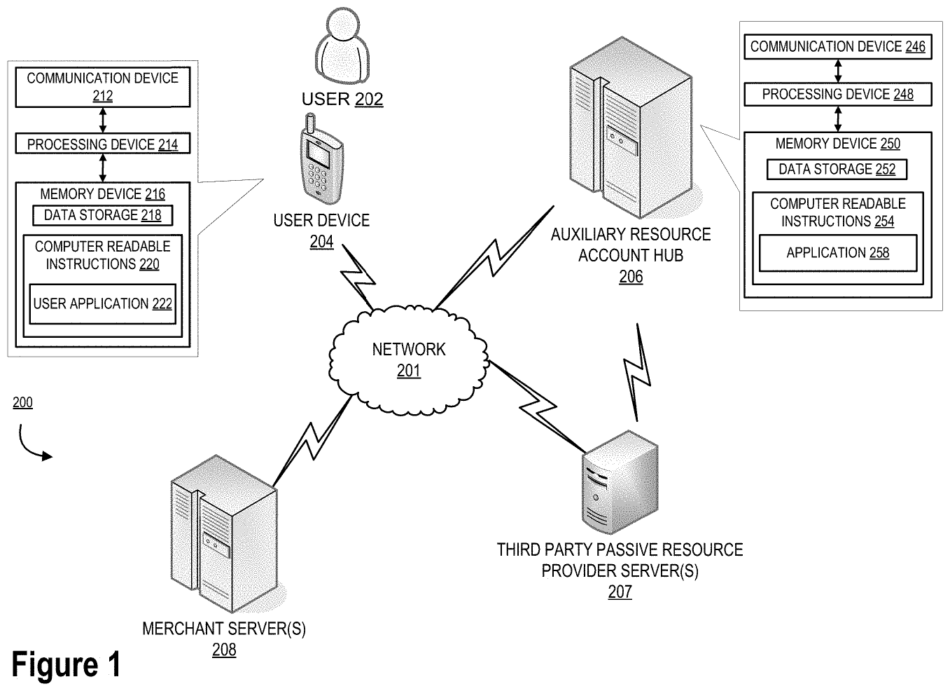

FIG. 1 provides a passive resource collection and transformation system environment 200, in accordance with one embodiment of the present invention. FIG. 1 provides the system environment 200 for which the distributive network system with specialized data feeds. FIG. 1 provides a unique system that includes specialized servers and system communicably linked across a distributive network of nodes required to perform the functions described herein.

As illustrated in FIG. 1, the merchant server 208 is operatively coupled, via a network 201 to the user device 204, third party passive resource provider servers 207, and to the auxiliary resource account hub 206. In this way, the merchant server 208 can send information to and receive information from the user device 204, third party passive resource provider servers 207, and the auxiliary resource account hub 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual with an account with a financial institution that may interact with a merchant to complete a transaction with the merchant. In some embodiments, the user 202 has a user device 204, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the auxiliary resource account hub 206, the merchant server 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the auxiliary resource account hub 206.

As further illustrated in FIG. 1, the auxiliary resource account hub 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant server 208, the third party passive resource provider server 207, and the user device 204. As such, the communication device 246 generally comprises a modem, server, or other device for communicating with other devices on the network 201.

As further illustrated in FIG. 1, the auxiliary resource account hub 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the auxiliary resource account hub 206 the memory device 250 stores an application 258. In one embodiment of the invention, the application 258 may associate with applications having computer-executable program code. Furthermore, the auxiliary resource account hub 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more merchant server 208, third party passive resource provider servers 207, and/or user device 204.

As illustrated in FIG. 1, the third party passive resource provider server 207 is connected to the merchant server 208, user device 204, and auxiliary resource account hub 206. The third party passive resource provider server 207 has the same or similar components as described above with respect to the user device 204 and the auxiliary resource account hub 206. While only one third party passive resource provider server 207 is illustrated in FIG. 1, it is understood that multiple third party passive resource provider servers 207 may make up the system environment 200. The third party passive resource provider server 207 may be associated with one or more financial institutions, entities, merchants, or the like that provide passive resources to the user 202.

As illustrated in FIG. 1, the merchant server 208 is connected to the third party passive resource provider server 207, user device 204, and auxiliary resource account hub 206. The merchant server 208 has the same or similar components as described above with respect to the user device 204 and the auxiliary resource account hub 206. While only one merchant server 208 is illustrated in FIG. 1, it is understood that multiple merchant server 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The merchant server 208 may generally include a processing device communicably coupled to devices as a memory device, output devices, input devices, a network interface, a power source, one or more chips, and the like. The merchant server 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the merchant server 208 described herein.

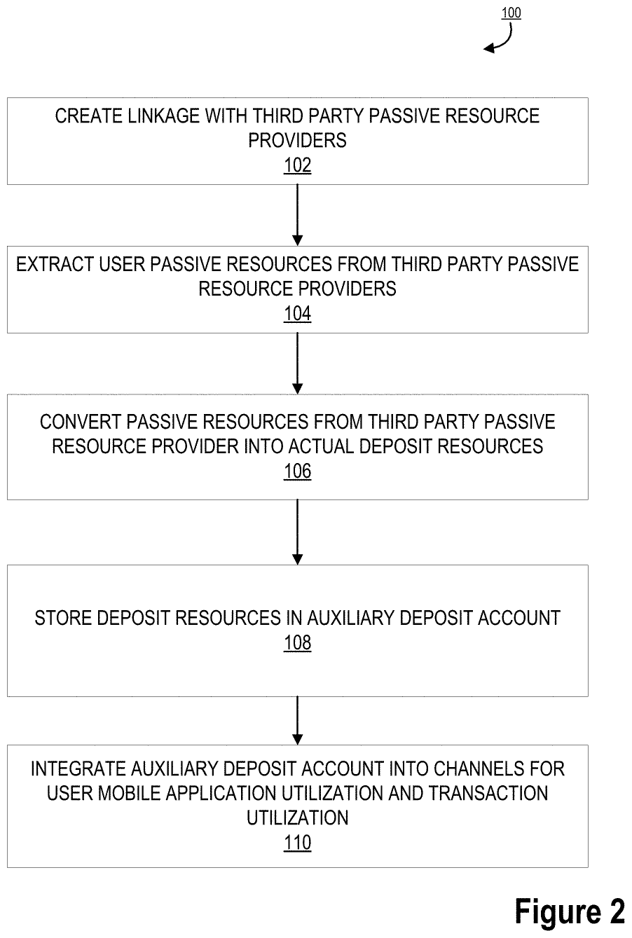

FIG. 2 illustrates setting up the passive resource collection and auxiliary resource account hub 100, in accordance with an embodiment of the invention. As illustrated in block 102, the process 100 is initiated by creating a linkage between the auxiliary resource account hub and the third party passive resource providers. The third party passive resource providers may include any entity, merchant, service provider, or the like that that may provide passive resources to users. The passive resources may be rewards, miles, bonuses, or the like provided to the user from the third party passive resource provider for user interaction with the provider. The interaction may be user use of the provider services, user purchases from the provider, or the like.

As illustrated in block 104, the process 100 continues by extracting user passive resources from third party passive resource providers. In this way, the system may recognize the passive resources the user may have accumulated with each of the third party providers, which may include merchants, service providers, or the like. The system may extract the user passive resources such as points, airline miles, cash back rewards, or other bonuses or rewards that the user may have acquired from the merchant. The system may use the linkage with the third party passive resource providers to extract, in real-time, the passive resources the user has accumulated. Furthermore, the linkage allows for providers to send the passive resources to the system directly without extraction being necessary.

As illustrated in block 106, once the system has the passive resources for the user, the system may convert the passive resources from the third party passive resource provider into an actual deposit resource. In this way, the system may convert airline miles, points, or other rewards into physical resources that are able to be utilized as a resource for completion of a transaction with any merchant. As such, the converted passive resources may act as and be the same as cash. The invention may utilize machine learning to actively predict the conversion ratio from the passive resource to the deposit resource that may be used as cash for a transaction. The conversion may be a ratio conversion, direct conversion, or the like based on the passive resource received.

Next, as illustrated in block 108, the process 100 continues by storing the deposit resources that have been converted from the passive resources in an auxiliary deposit account for the user utilization for completion of transactions. Finally, as illustrated in block 110, the process 100 is finalized by integrating the auxiliary deposit account into the channels at the financial institution for user mobile application utilization and transaction utilization. As such, the system may incorporate the auxiliary deposit account into the user mobile applications, on line applications, and the like such that the auxiliary deposit account is integrated and viewable by the user when viewing his/her other deposit accounts. Furthermore the auxiliary deposit account may be used as over a limit protection for other accounts associated with the user.

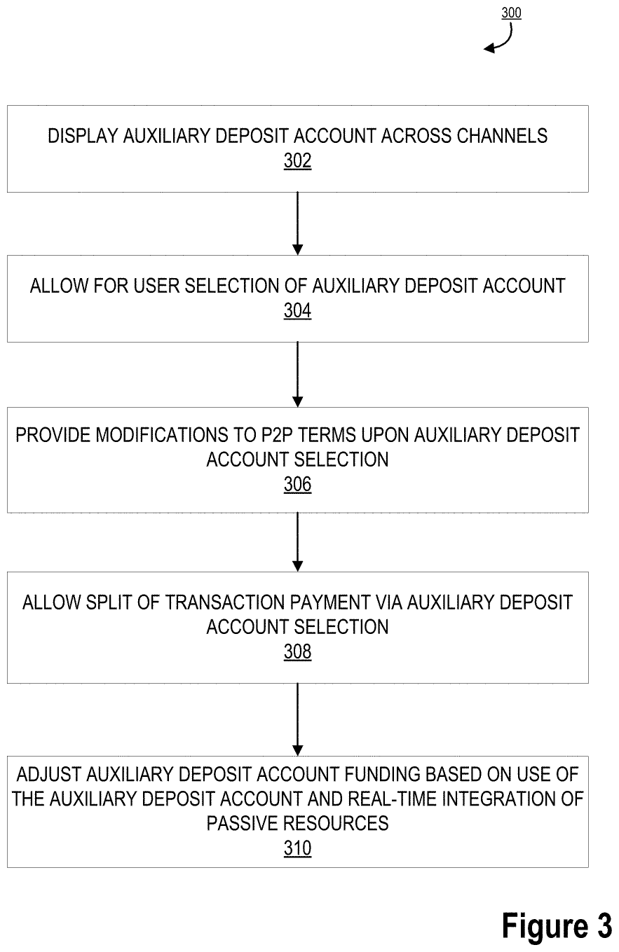

FIG. 3 provides a process flow illustrating utilization of the auxiliary resource account hub 300, in accordance with one embodiment of the present invention. As illustrated in block 302, the process 300 is initiated by displaying the auxiliary deposit account across channels to the user. In this way, the system may integrate and display the auxiliary deposit account on the user's mobile application, online applications, and the like where the user may visualize his/her other deposit accounts such as savings accounts, checking accounts, and the like.

As illustrated in block 304, the process 300 continues by allowing for user selection of the auxiliary deposit account as an option for payment for a transaction. The selection of the auxiliary deposit and subsequent transaction may be performed via mobile wallet, P2P payment, or the like. Upon identification of the transaction occurring via P2P payment, the system may trigger a modification to the P2P requirements. As such, as illustrated in block 306, the process 300 may continue by providing the modifications to the P2P terms upon auxiliary deposit account selection. The term modification may be triggered based on the use of the auxiliary deposit account for a P2P transaction. The term modification may be a limit modification for increasing the limit of the P2P transaction based on the use of the auxiliary deposit account.

Furthermore, as illustrated in block 308, the system may also allow for a split of the transaction payment when the auxiliary deposit account is selected for transaction completion. In this way, the system may allow a user to split a portion of the transaction between multiple accounts, as such allowing the auxiliary deposit account to account for a portion of the transaction cost and a separate deposit account accounting for the remainder of the transaction costs.

Finally, as illustrated in block 310, the process 300 is finalized by adjusting the auxiliary deposit account resource amount based on the use of the auxiliary account and real-time updating of the passive resources into the auxiliary account. As such, the resource amount in the auxiliary deposit account may be modified based on when the user utilized the account for a transaction and/or when the user is receiving passive resources from one or more merchants.

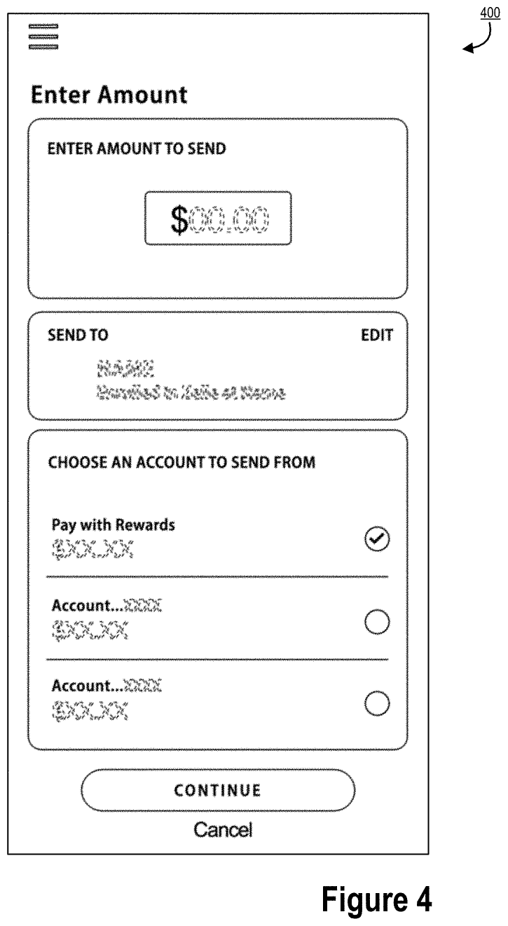

FIG. 4 provides a graphical user interface of the auxiliary resource account hub integration 400, in accordance with one embodiment of the present invention. The graphical user interface 400 illustrates the integration of the auxiliary deposit account, as a “pay with rewards” account along with other deposit accounts available to the user. As illustrated, the user may be able to select an amount to send to a merchant or other user via P2P payment. Once an amount is selected, the user may be able to select the individual or entity to send the resources to. Finally, as illustrated, the system integrates the auxiliary resource account with other deposit accounts associated with the user and allows the user to select the auxiliary resource account (e.g. pay with rewards account) for transferring of actual resources to another user.

Currently, users have an expanded rewards collection from credit cards, third party rewards accounts, and the like that are collected as passive or auxiliary resources. The invention provides a centralized functioning deposit account for the user for utilization of the passive resources across any merchant or deposit function. This centralized functioning deposit account may be an auxiliary deposit account that stores converted passive resources into usable deposit resources for the user. The user may then be able to utilize this centralized auxiliary account for completion of person-to-person (P2P) transactions, transactions at a merchant, or the like. As such, the user may be able to select from checking, savings, of this auxiliary account to transfer money via P2P. In this way, the invention enables rewards as a funding/deposit account. The invention further provides a graphical user interface that allows for user splitting of resources for a single transaction between multiple accounts. As a funding source, the invention allows for the auxiliary account to go over the send limit for items like P2P payments or other digital payments. The system may also allow for universal transfer of rewards across various third party entities into the centralized auxiliary account for the user. In this way, the invention provides a real-time identification of rewards available within the centralized auxiliary account before or during a transaction. The system may also link to a user's digital wallet for easy access and visualization.

Embodiments of the present invention address these and/or other needs by providing an innovative system, method and computer program product for passive resource transformation, the invention comprising: creating a communication linkage with third party passive resource providers; receiving passive resources from the third party passive resource providers specific for a user; converting the passive resources; storing the converted passive resources in a centralized auxiliary resource account; integrating the auxiliary resource account into user channels; triggering term modification of resource distribution upon user selection of the auxiliary resource account for a resource distribution; and adjusting the auxiliary resource account.

In some embodiments, converting the passive resources comprises determining a type of passive resource and converting the passive resource into a deposit resource in a ration based on a relative value of the passive resource. In some embodiments, receiving passive resources from the third party passive resource providers further comprises extracting the passive resources from the third party passive resource providers for the user based on user authorization. In some embodiments, adjusting the auxiliary resource account further comprises modifying an amount of resources in the auxiliary resource account based on user use of the auxiliary resource account for transactions and a real-time integration of the passive resources received from the third party passive resource providers specific for the user.

In some embodiments, the term modification comprises a modification and increase of a resource distribution limit for P2P transactions using the auxiliary resource account. In some embodiments, the term modification comprises allowing the use of the auxiliary resource account and another deposit account to complete a single transaction. In some embodiments, third party passive resource providers comprise entities providing products or services to the user and including a reward in the form of a passive resource to the user for interaction with the third party passive resource provider. In some embodiments, integrating the auxiliary resource account into user channels further comprises integrating the auxiliary resource account with deposit accounts of the user within a mobile application for resource distribution.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for passive resource transformation, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
create a communication linkage with third party passive resource providers;
receive passive resources from the third party passive resource providers specific for a user;
convert the passive resources;
store the converted passive resources in a centralized auxiliary resource account;
integrate the auxiliary resource account into user channels;
trigger term modification of resource distribution upon user selection of the auxiliary resource account for a resource distribution; and
adjust the auxiliary resource account.

2. The system of claim 1, wherein converting the passive resources comprises determining a type of passive resource and converting the passive resource into a deposit resource in a ration based on a relative value of the passive resource.

3. The system of claim 1, wherein receiving passive resources from the third party passive resource providers further comprises extracting the passive resources from the third party passive resource providers for the user based on user authorization.

4. The system of claim 1, wherein adjusting the auxiliary resource account further comprises modifying an amount of resources in the auxiliary resource account based on user use of the auxiliary resource account for transactions and a real-time integration of the passive resources received from the third party passive resource providers specific for the user.

5. The system of claim 1, wherein the term modification comprises a modification and increase of a resource distribution limit for P2P transactions using the auxiliary resource account.

6. The system of claim 1, wherein the term modification comprises allowing the use of the auxiliary resource account and another deposit account to complete a single transaction.

7. The system of claim 1, wherein third party passive resource providers comprise entities providing products or services to the user and including a reward in the form of a passive resource to the user for interaction with the third party passive resource provider.

8. The system of claim 1, wherein integrating the auxiliary resource account into user channels further comprises integrating the auxiliary resource account with deposit accounts of the user within a mobile application for resource distribution.

9. A computer program product for passive resource transformation, the computer program product comprising at least one non-transitory computer-readable medium having computer-readable program code portions embodied therein, the computer-readable program code portions comprising:
an executable portion configured for creating a communication linkage with third party passive resource providers;
an executable portion configured for receiving passive resources from the third party passive resource providers specific for a user;
an executable portion configured for converting the passive resources;
an executable portion configured for storing the converted passive resources in a centralized auxiliary resource account;
an executable portion configured for integrating the auxiliary resource account into user channels;
an executable portion configured for triggering term modification of resource distribution upon user selection of the auxiliary resource account for a resource distribution; and
an executable portion configured for adjusting the auxiliary resource account.

10. The computer program product of claim 9, wherein converting the passive resources comprises determining a type of passive resource and converting the passive resource into a deposit resource in a ration based on a relative value of the passive resource.

11. The computer program product of claim 9, wherein receiving passive resources from the third party passive resource providers further comprises extracting the passive resources from the third party passive resource providers for the user based on user authorization.

12. The computer program product of claim 9, wherein adjusting the auxiliary resource account further comprises modifying an amount of resources in the auxiliary resource account based on user use of the auxiliary resource account for transactions and a real-time integration of the passive resources received from the third party passive resource providers specific for the user.

13. The computer program product of claim 9, wherein the term modification comprises a modification and increase of a resource distribution limit for P2P transactions using the auxiliary resource account.

14. The computer program product of claim 9, wherein the term modification comprises allowing the use of the auxiliary resource account and another deposit account to complete a single transaction.

15. The computer program product of claim 9, wherein third party passive resource providers comprise entities providing products or services to the user and including a reward in the form of a passive resource to the user for interaction with the third party passive resource provider.

16. The computer program product of claim 9, wherein integrating the auxiliary resource account into user channels further comprises integrating the auxiliary resource account with deposit accounts of the user within a mobile application for resource distribution.

17. A computer-implemented method for passive resource transformation, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
creating a communication linkage with third party passive resource providers;
receive passive resources from the third party passive resource providers specific for a user;
converting the passive resources;
storing the converted passive resources in a centralized auxiliary resource account;
integrating the auxiliary resource account into user channels;
triggering term modification of resource distribution upon user selection of the auxiliary resource account for a resource distribution; and
adjusting the auxiliary resource account.

18. The computer-implemented method of claim 17, wherein converting the passive resources comprises determining a type of passive resource and converting the passive resource into a deposit resource in a ration based on a relative value of the passive resource.

19. The computer-implemented method of claim 17, wherein receiving passive resources from the third party passive resource providers further comprises extracting the passive resources from the third party passive resource providers for the user based on user authorization.

20. The computer-implemented method of claim 17, wherein adjusting the auxiliary resource account further comprises modifying an amount of resources in the auxiliary resource account based on user use of the auxiliary resource account for transactions and a real-time integration of the passive resources received from the third party passive resource providers specific for the user.
